(19) United States
(12) Patent Application Publication
(10) Pub. No.: US 2015/0316921 A1
(43) Pub. Date: Nov. 5, 2015

(54) SYSTEM AND METHOD OF MEASUREMENT, IDENTIFICATION AND ANALYSIS OF MATERIAL LIFTING PRODUCTS USING REMOTE MONITORING

(71) Applicant: The Crosby Group LLC, Tulsa, OK (US)

(72) Inventor: Matthew Atherton, Tulsa, OK (US)

(21) Appl. No.: 14/699,698

(22) Filed: Apr. 29, 2015

Related U.S. Application Data
(60) Provisional application No. 61/988,683, filed on May 5, 2014.

(51) Int. Cl. G05B 19/4065

(52) U.S. Cl. CPC G05B 19/4065; G05B 2219/37086

(57) ABSTRACT

A system and method of measurement, identification and analysis of material lifting products using remote monitoring. The method includes designing a lift plan for a load including various equipment and a plurality of legs. A lift sensing and monitoring device is selected for each of the legs and connected thereto. Load data is transmitted from each of the lift sensing and monitoring devices during the lift to a mobile receiving and transmitting device. An alert is generated if any tension value from the load data is greater than capacity.

### CROSS REFERENCE TO RELATED APPLICATIONS

This application claims priority to U.S. Provisional Patent Application No. 61/988,683, filed May 5, 2014, which is herein incorporated by reference.

### BACKGROUND OF THE INVENTION

1. Field of the Invention

The present invention relates to a system and method of measurement, identification and analysis of material lifting products using remote monitoring. In particular, the present invention is directed to a method and system of measuring, identifying and analyzing loads applied to rigging equipment, such as shackles, hooks, hoist rings, chain or wire rope slings, and other associated components, both in planning and during a lifting operation or procedure.

2. Prior Art

Lifting of large loads or complex load shapes often involves multiple attachment points. In some applications, lifting is performed by connecting the attachment points to a central gathering component via multiple legged slings. The central gathering component is, in turn, attached to a crane or other load lifting device.

Loads are calculated, but may not always be known. In addition, loads can shift, resulting in one leg of the sling experiencing more load than the other legs. An unusual center of gravity of the load can have a similar effect.

Chain or wire rope slings, their shackles, hooks, and other rigging hardware have established working load limits. Exceeding these limits can have negative effects.

It would, therefore, be desirable to provide a system to remotely monitor the applied loads, compare these loads to the limits of the rigging components, both individually and together, and to alert the user to an overload situation.

It would also be desirable to provide a system having multiple load sensing devices which remotely transmit data to a wireless receiving device.

It would also be desirable to provide a system of measurement, identification and analysis that includes stored information on size, capacity, use and safety factors of various lifting equipment.

It would also be desirable to provide a system to plan a lift operation, choose appropriate equipment for the lift, and monitor the loads applied during the lift operation.

### BRIEF DESCRIPTION OF THE DRAWINGS

FIG. 1 illustrates a perspective view of a load and fittings for a system and method of measurement, identification and analysis of material lifting products of the present invention;

FIG. 2 illustrates a simplified schematic flowchart diagram of the planning stages of the system and method of the present invention;

FIGS. 3 and 4 illustrate screen shots of a display of a mobile receiving and transmitting device utilized in connection with the present invention;

FIG. 5 is a simplified schematic flowchart diagram of system set up phases of the present invention;

FIG. 6 is a simplified schematic flowchart diagram illustrating lift monitoring devices of the system of the present invention;

FIG. 7 is a simplified schematic flowchart diagram of the rigging phase of the present invention;

FIG. 8 is a simplified schematic flowchart diagram of the procedure right before a lift in accordance with the present invention; and

FIG. 9 is a simplified schematic flowchart diagram of the process flow during the lift operation of the present invention.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

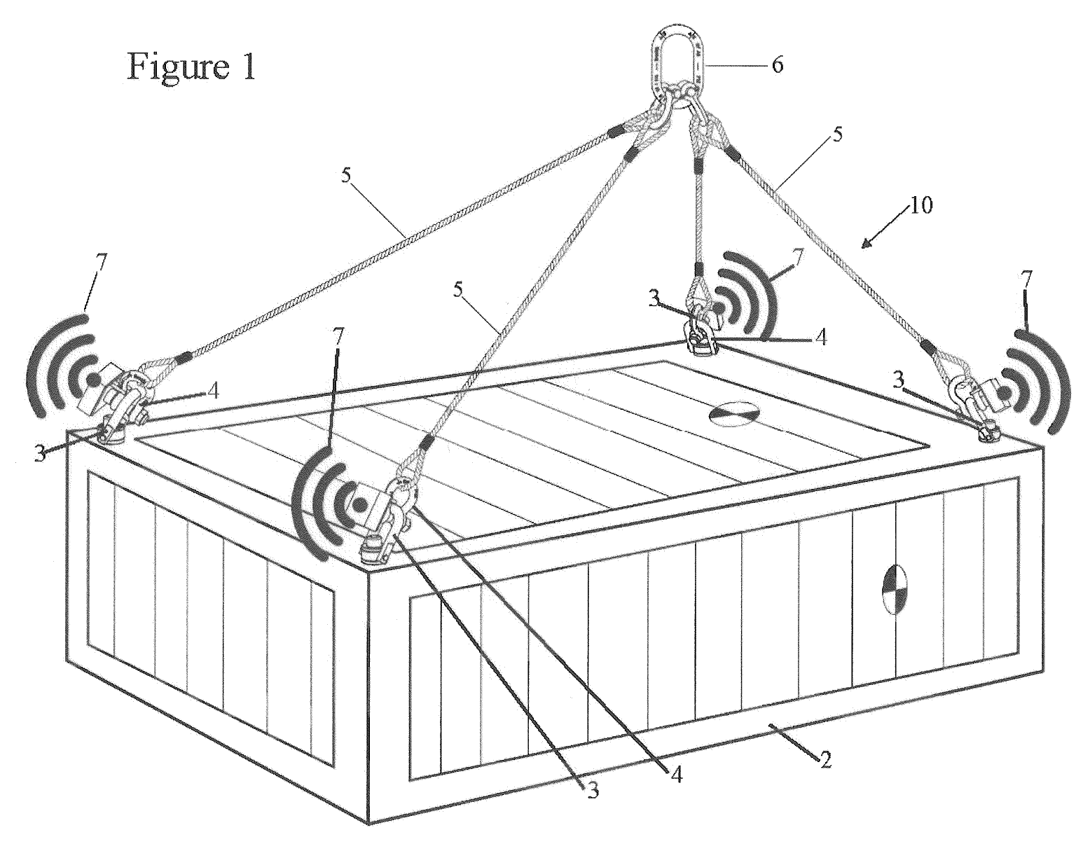

Referring to the drawings in detail, FIG. 1 illustrates a simplified, perspective view of a system 10 having a load 2 to be lifted with lifting equipment configured, connected and operated in accordance with the present invention. The load 2 may be in various sizes or shapes. The load 2 will have multiple connections or lift points in the form of eyebolts 3. Other types of connection or lift points might alternately be utilized. Although four connection or lift points and four legs are shown in the example herein, it will be appreciated that a greater or lesser number may be employed within the spirit and scope of the invention.

A lift connector device, such as a shackle 4 or a hook is removably connected to each of the eyebolts 3. One end of a chain or synthetic sling 5 is, in turn, connected to each of the shackles 4. An opposed end of each sling 5 is connected to a master link 6, which, in turn, might be connected to a crane or other lifting device (not shown).

Each shackle 4 or hook includes a lift sensing and monitoring device load cell, strain gauge or the like, mounted on or embedded therein, which would sense a change in electrical resistance based on the load applied. A load cell is a sensor or a transducer that converts a load or force acting on it into an electronic signal. This electronic signal can be a voltage change, current change or frequency change depending on the type of load cell and circuitry used. Load cells (or load sensors as they are called) can be made using resistive, capacitive, inductive or other techniques. Most commonly available load cells are based on the principle of change of resistance in response to an applied load. This is termed piezo-resistive i.e. something that changes in response to an applied pressure (or squeezed). In one non-limiting example, the load cell would include a spool of metal which generates a voltage under strain. The load cell would, in turn, be connected to a wireless transmitter which transmits data via transmission signals 7, illustrated by bars.

The wireless transmitter is capable of transmitting data from the load cell to a mobile receiving and transmitting device such as, but not limited to, a laptop computer, a tablet computer or cellular phone. This may be accomplished by radio frequency transmission, such as Bluetooth™ transmission. For a load having multiple legs and multiple wireless transmitters, the mobile receiving and transmitting device will receive data from each of the plurality of wireless transmitters. The mobile receiving device will include a central processing unit and will either include or have access to a database for storage of data. The mobile receiving and transmitting device will include or be connected to a display.

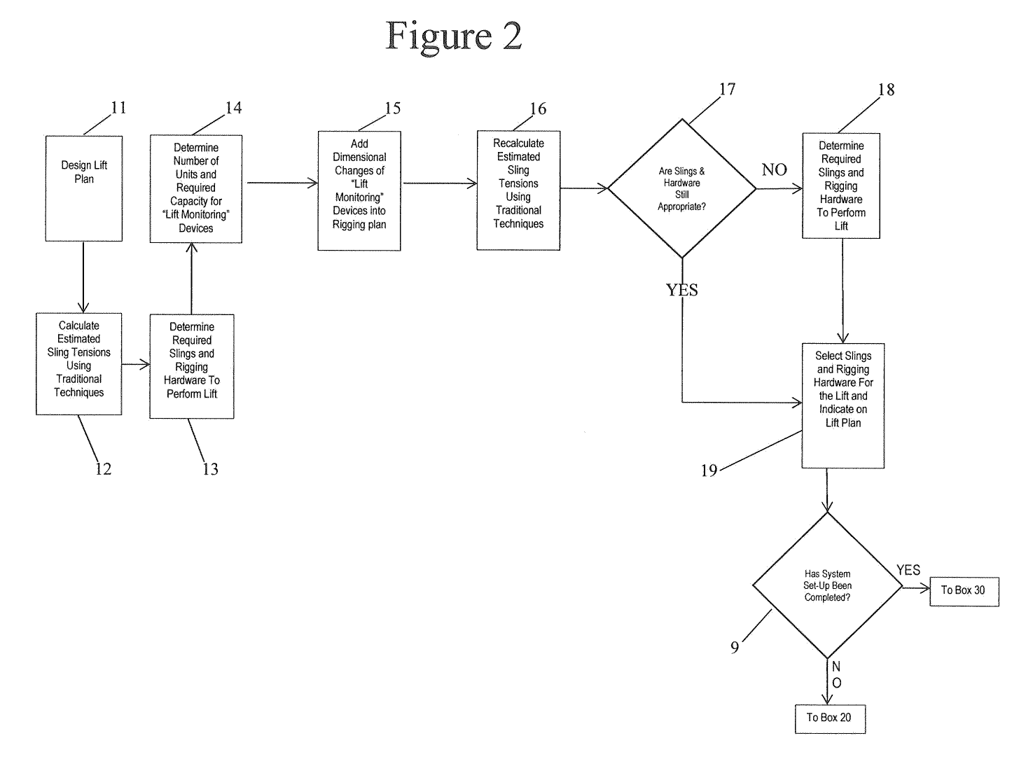

FIGS. 2 and 5 through 9 illustrate sequential schematic flow charts of both the process and the system of the present invention.

As seen in FIG. 2, initially a lift or rigging plan is designed in advance of the lift operation as set forth in Box 11, such as a plan by a qualified lift engineer. The lift plan will involve analysis of the load to be lifted, the conditions, the lifting device, such as a crane, the personnel, the equipment on hand, and the equipment to rent, buy or fabricate. A non-limiting list of considerations for a lift or rigging plan includes:

1. Who is responsible for the rigging?

2. Have communications been established?

3. Is all of the equipment in acceptable condition?

4. Is the rigging appropriate for lifting?

5. Does the equipment have proper identification?

6. Does all gear have known working load limits?

7. What is the weight of the load?

8. Where is the load's center of gravity?

9. What is the sling angle?

10. Will there be any side or angular loading?

11. Are the slings padded against corners, edges, protrusions or abrasive surfaces?

12. Are the working load limits adequate?

13. Is the load rigged to the center of gravity?

14. Is the hitch appropriate for the load?

15. Is a tag line required to control load?

16. Will personnel be clear of suspended loads?

17. Is there any possibility of fouling?

18. Will the load lift level and be stable?

19. Are there any unusual environmental concerns?

20. Are there any special requirements?

The foregoing list of considerations can be stored and displayed on the mobile receiving and transmitting device to be described in detail herein.

The rigging and all of the equipment must be used within manufacturers' recommendations and within various industry and governmental standards that include OSHA, ASME, ANSI, API and others.

As seen in Box 12, the tension in each sling is determined in the process of planning the lift, based on the load's weight and the angles of the slings using traditional techniques. Traditional known techniques for planning a lift involve the use of trigonometry to calculate tensions by applying a sling angle multiplier to the vertical share of the load for each sling. This sling angle multiplier is determined by the length of the sling, divided by the height of the rigging triangle. This technique can be illustrated using the following example:

A rectangular load, weighing 12,500 lbs. must be lifted. The load is 27.5 inches by 27.5 inches square (2.3 feet by 2.3 feet). The depth of the load is 1.75 inches. In this case, there will be very limited head room, and the height of the rigging triangle can be no greater than 3 feet.

| Load Information: | | |
|---|---|---|
| Width | 2.3 | ft |
| Height | .15 | ft |
| Length | 2.3 | ft |
| Material | Custom (15752.99 lbs./ft³) | |
| Weight | 12,500 | lbs. |
| Hitch Information: | | |
| Hitch Type | 4-Leg | |
| Height | 2.53 | ft |
| Pick Point | 0.12 | ft |
| Leg Length | 2.91 | |
| Sling angle | 60° | |
| Tension in each leg | 4,812 | lbs. |

Tensions are based on 3 legs carrying an equal share of the load.

A four-legged bridle hitch is desired to lift this rectangular load, using wire rope. FIG. 1 illustrates an example of a rigging assembly. The lift planner must determine what size wire rope sling to use, and thereby determine what size fasteners to use. The first step in determining the size of the wire rope is to establish the number of legs that will be assumed to share the weight of the load. Often, when a load is rigged with four legs, only three legs actually carry the load (the three points form a plane), and the fourth leg performs more of a balancing function. But all legs must be able to support this calculated tension.

Knowing this, a plan can be made for the vertical share of the load in each leg to be ⅓ the weight of the load. 12,500 divided by 3−4,167 lbs. rounded up.

However, the load will not be lifted from four points vertically—the slings will be gathered into a collector ring, so there will be a horizontal component (or crushing force) that will increase the tension in each sling.

A 60 degree horizontal sling angle is often desired when creating a multi-leg, or bridle, hitch. This sling angle gives a known multiplier of approximately 1.155. Multiplying the vertical share of the load by this number, we get 1.155×4,167=4813 lbs. for the calculated tension in each leg.

The size of the wire rope chosen must therefore be able to withstand 4,813 lbs. at the minimum, or 2.4 US Tons.

Consulting a chart for capacities, a ½ inch wire rope has a working load limit of 2.5 US Tons.

Knowing that the wire rope will be ½ inch permits sizing the other fittings.

Starting at the bottom of the load, the slings need to attach to fasteners to the load. The use of swivel hoist rings is anticipated, so shackles are needed to connect the bottom of each sling to the swivel hoist rings.

The fastener should ideally be at least one size “up” from the wire rope in order to avoid damage to the wire rope. This means the shackle at the bottom of the hook should be one size greater than the ½ inch size.

A ⅝ inch shackle is an appropriate size, and can easily support the 2.4 US Tons because it has a working load limit of 3.25 metric tons (or 7165 lbs., compared to our 4,813 pounds that will be required).

The smallest size swivel hoist ring that can support the 4,813 pounds is the 5,000 lb. size. Checking the dimensions, we compare the diameter of the bolt of the shackle to the radius of the swivel hoist ring, to make sure the bolt won't be too big for the hoist ring. In turn, the diameter of the hoist ring is compared to the “ear spread” of the shackle, to make sure that the hoist ring is not too large for the shackle (the diameter of hoist ring to the opening of shackle).

With the load fasteners and the lower fittings selected, the top of each sling is considered.

Collecting all four slings into a single point is often not ideal. Not only can bunching occur, but if a master link is formed into the eyes of the wire rope slings, the option to replace a single bad leg of the bridle requires much more time and expense. Instead, by using shackles, all four legs can be collected into a single point. To avoid bunching, it is often ideal to collect only two legs into a single shackle, and then connect the shackles to a master link, which provides the single lifting point.

Each of the two top shackles must be greater than the ½ inch diameter of the wire rope, however, the shackles must be even larger than ⅝ inch, because each shackle will be supporting two legs of the load, and the tension in a single leg of the load is 4,813 lbs.

To determine the required capacity for each of these top shackles, the correct technique is to take the sum of the tensions and multiply that sum by the cosine of half of the included angle. In this case, the included angle is 60 degrees. That means that the top shackles must each be able to support 8,336 lbs. (2 times 4,813 lbs.=9,626 lbs. times the cosine of 30 degrees, or roughly 0.866, gives a resulting load of 8,336 lbs.) In this example, the appropriate size shackles are the ¾″ shackles, which can support 10,471 lbs. each.

Bolt type shackles are chosen for the two top shackles although the other types might be employed.

The master link must be able to support the entire load, plus the rigging weight (wire rope, shackles, and fasteners at this point). With 15,200 lbs. of capacity, a ⅞″ master link will perform adequately, and its dimensions will allow the two top shackles to easily fit within the link while not being so large as to create a conflict with the ears of the shackle and the diameter of the master link.

The foregoing example illustrates the traditional calculation for selection of equipment.

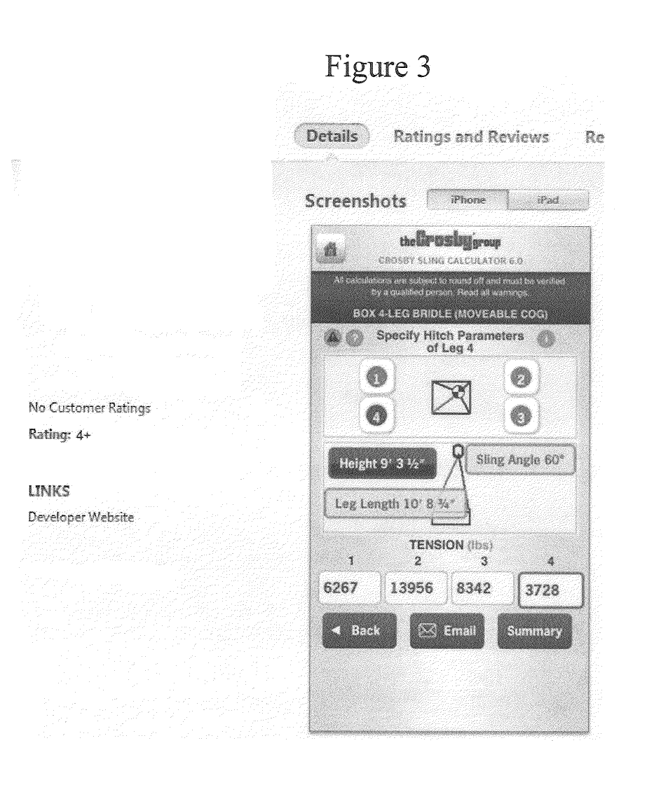

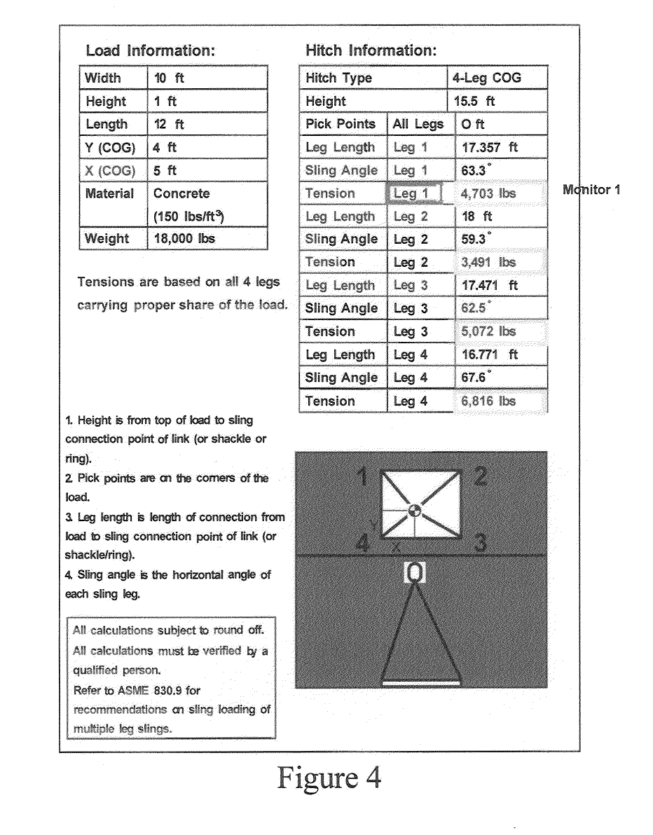

In the present invention, the selection of equipment and calculations are aided by the mobile receiving and transmitting device. FIGS. 3 and 4 illustrate screen shots of a display of a mobile receiving and transmitting device showing a basic sample calculation. The mobile receiving and transmitting device receives data from the wireless transmitter.

Returning to the sequential flow chart in FIG. 2, as seen in Box 13, once the anticipated tension is known, the equipment, such as the slings and the other components, can be sized to make a lift.

As seen in Box 14, with a four-leg lift, each lift sensing and monitoring device should be sized appropriate to the expected capacity that each leg of the load will encounter. It is possible to just size them all for the worst case scenario, however, that assumes all legs will carry their share of the load. A precautionary assumption is that only two legs would carry the load, and size the monitoring devices for this worst case scenario so that the lift monitoring devices don't become an overloaded component of the lift.

As seen in Box 15, if the lift sensing and monitoring devices have a length that is inline with the load, their addition will necessarily alter the lift plan. The slings would now each become slightly longer. Accommodation for this additional length should be taken into account. That only helps the sling angles and decreases the tension in each leg.

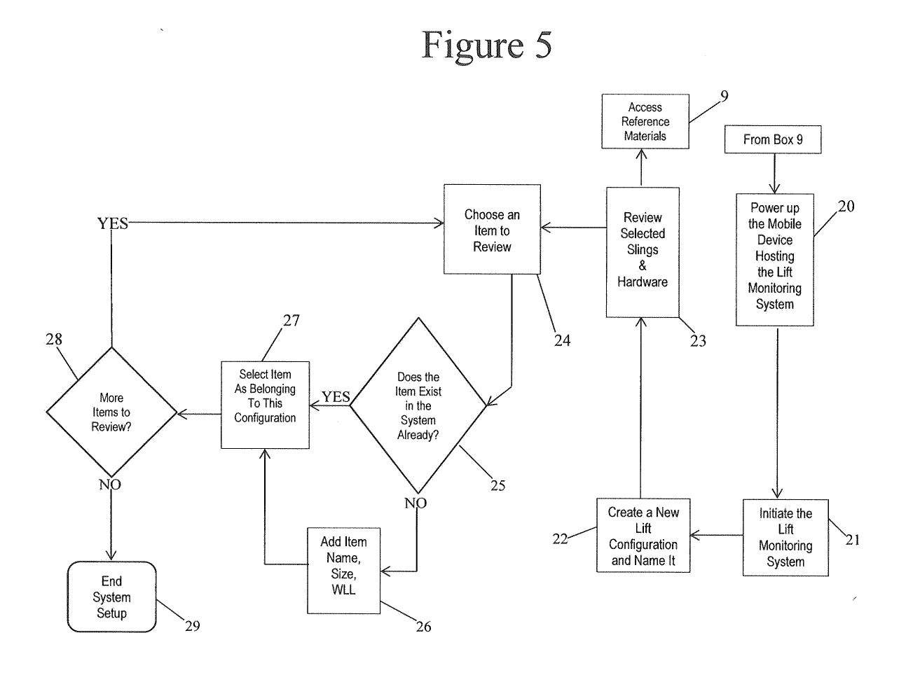

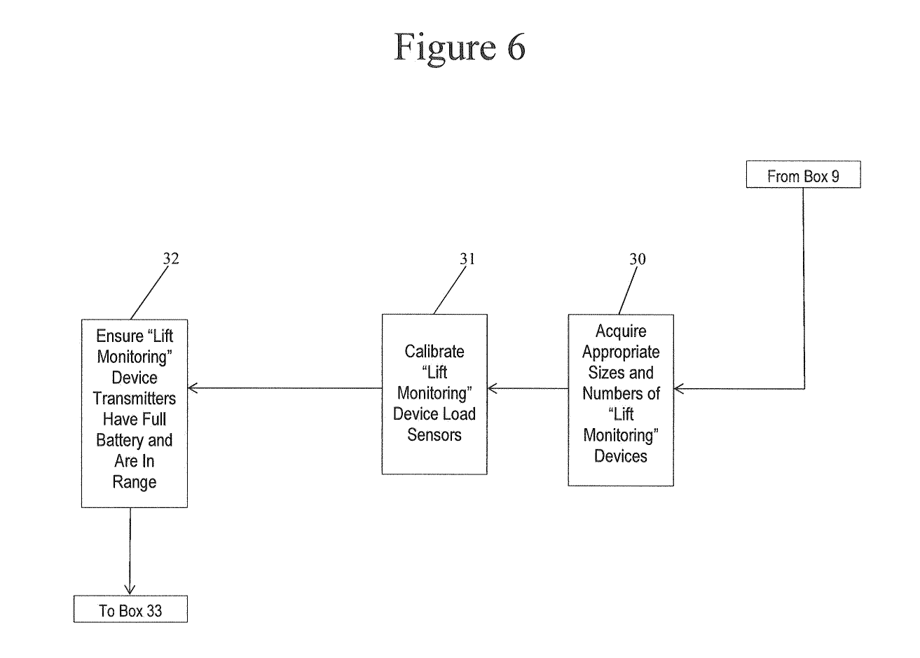

As seen in Box 16, reconfiguring any of the equipment will require recalculation. If everything is still sized correctly, then the process will proceed to Box 19. Otherwise, as seen in Box 18, everything will be resized to make sure that the capacities are correct. At this point, all slings, hardware and equipment should be selected and adequate for the anticipated lift operation. As seen in Diamond 9, if the system set-up has not yet been completed, then the system set-up phase will be initiated at Box 20 in FIG. 5. If the system set-up phase has been completed, then the lift monitoring device phase can be initiated as seen at Box 30 in FIG. 6.

FIG. 5 illustrates a sequential flow chart of the system set up phase after the planning phase just described in FIG. 2.

As seen in Box 20, the mobile receiving and transmitting device, which includes a central processing unit, runs a computer software application will be turned on or powered up. The mobile receiving and transmitting device may be a laptop computer, a tablet computer or a mobile telephone.

Thereafter, as seen in Box 21, the lift monitoring computer software application program will be initiated.

Thereafter, as seen in Box 22, a display or screen on the mobile receiving and transmitting device will allow the user to create a name for a new project, which the user can name so that it can be stored and retrieved at the time of the lift operation. The lift data including the load and all equipment may be stored under this designation.

As seen in Box 23, looking at the lift plan, the user, such as the lift engineer, will review all of the hardware sizes and slings chosen in order to execute the lift operation previously stored in the database.

As seen in Box 9, the user may access reference materials regarding the equipment items. For example, information on the attributes of each piece of equipment may be accessed.

As seen in Box 24, checking off the equipment items one by one from the list, the user should see if that equipment item already exists in the system's “global inventory”, which consists of both pre-loaded parts and any custom parts that the user has already created.

As seen in Diamond 25, if the equipment item is not already in the inventory, then, as seen in Box 26, the user would add the name of the equipment item, the size, the working load limit (WLL), and any other important details to the global inventory. Once the item for review has been entered (or was already there), then the user “adds” a reference to that item to the current project as shown at Box 26.

As seen in Diamond 28, if more equipment items are to be reviewed, they are added (which may require adding the items to the global inventory). As seen in Box 29, this will complete the system set-up operation. If these steps aren't performed before the day of the lift, they will be done at the time of the lift prior to the actual lifting procedure.

FIG. 6 illustrates a sequential flow chart of the steps regarding the lift monitoring device or devices phase of the present invention which normally takes place after the planning phase completed at Box 9 in FIG. 2.

As seen in Box 30, the appropriate size and number of sensing and monitoring devices will be obtained. In the present example, four devices will be utilized, one for each leg.

As seen in Box 31, the lift sensing and monitoring devices are calibrated correctly prior to the lift.

As seen in Box 32, it is desirable to confirm that each of the devices has full battery power and is in range of a mobile receiving and transmitting device to be described herein. Thereafter, the process continues on to the rigging phase.

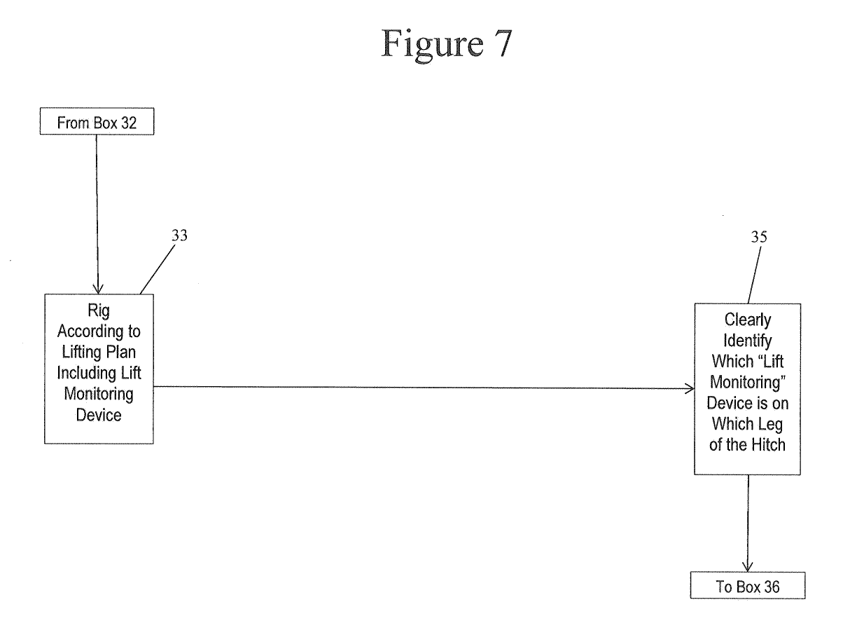

FIG. 7 illustrates a sequential flow chart of the rigging phase of the process of the present invention.

As seen in Box 33, all of the lift equipment previously chosen, including all of the lift monitoring devices, will be assembled according to the lifting plan.

As seen n Box 35, a labeling mechanism will be employed to clearly indicate the Number on each leg. This is important to later associate different hardware with a Leg Number.

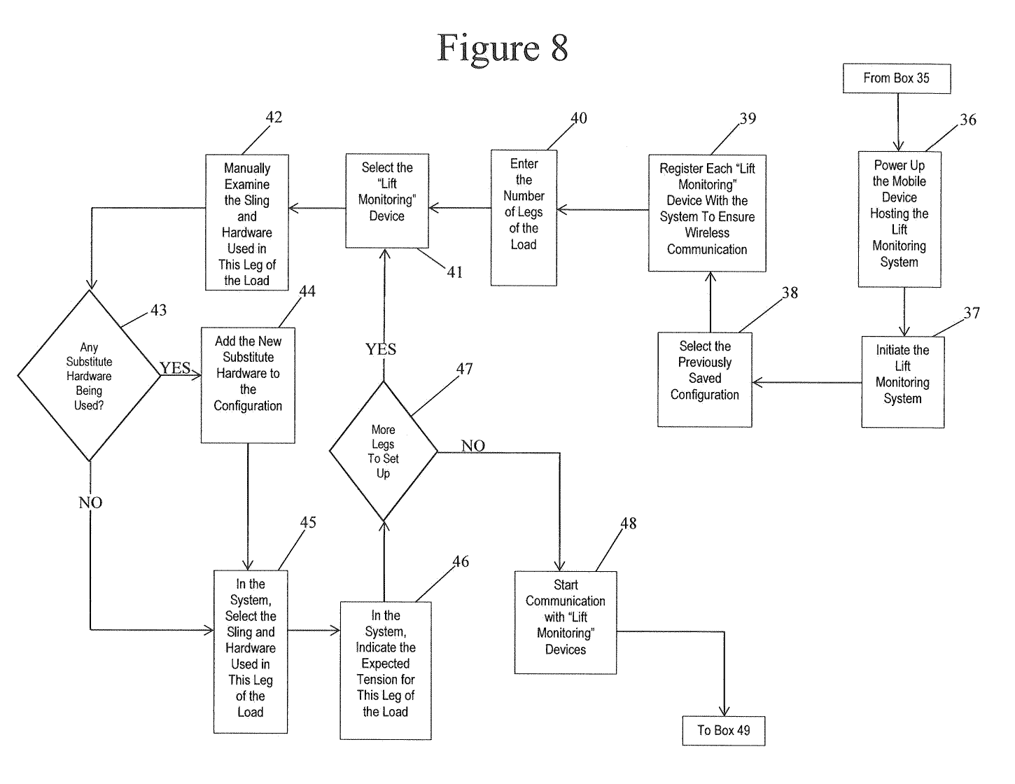

FIG. 8 illustrates a sequential flow chart of the procedure right before an actual lift operation and after the rigging phase.

As seen in Box 36, similar to Box 20, the physical handheld mobile receiving and transmitting device that will be running the computer software program will be started or powered up.

Thereafter, as seen in Box 37, similar to Box 21, the monitoring software application will be started.

As seen in Box 38, the user will access the database and open up the saved configuration file for the lift operation.

As seen in Box 39, the software establishes communication with each sensing and monitoring device (either directly or indirectly, such as through a router). This step might include a WiFi network, direct Bluetooth™ communication, or direct cellular communication. Once this step is complete, all lift monitoring devices will be “online” and can start feeding load sensing data to the software application of the mobile receiving device.

As seen in Box 40, the program is instructed with how many legs are in the assembly. In the present example, four legs are utilized.

As seen in Box 41, the lift monitoring device on “Leg 1” is chosen.

As seen in Box 42, all of the physical rigging equipment on the current leg will be checked by physical inspection.

As seen in Diamond 43, a check will be made if any last-minute replacement has occurred. If a replacement did occur, then, as seen in Box 44, the new equipment will be added to the global inventory and then added to the present configuration.

As seen in Box 45, with the hardware piece in the “configuration inventory”, it will be selected and associated with the leg that is currently being worked on.

As seen in Box 46, the expected tension for the selected leg will be indicated. If there are more legs to set up, then, as seen in Diamond 47, set up the rest of the legs (in the four-leg example, repeat steps 41-46 three more times).

As seen in Box 48, communication will be initiated to start receiving and pulling in data from each of the lift monitoring devices. In particular, data input is received at the mobile receiving and transmitting device.

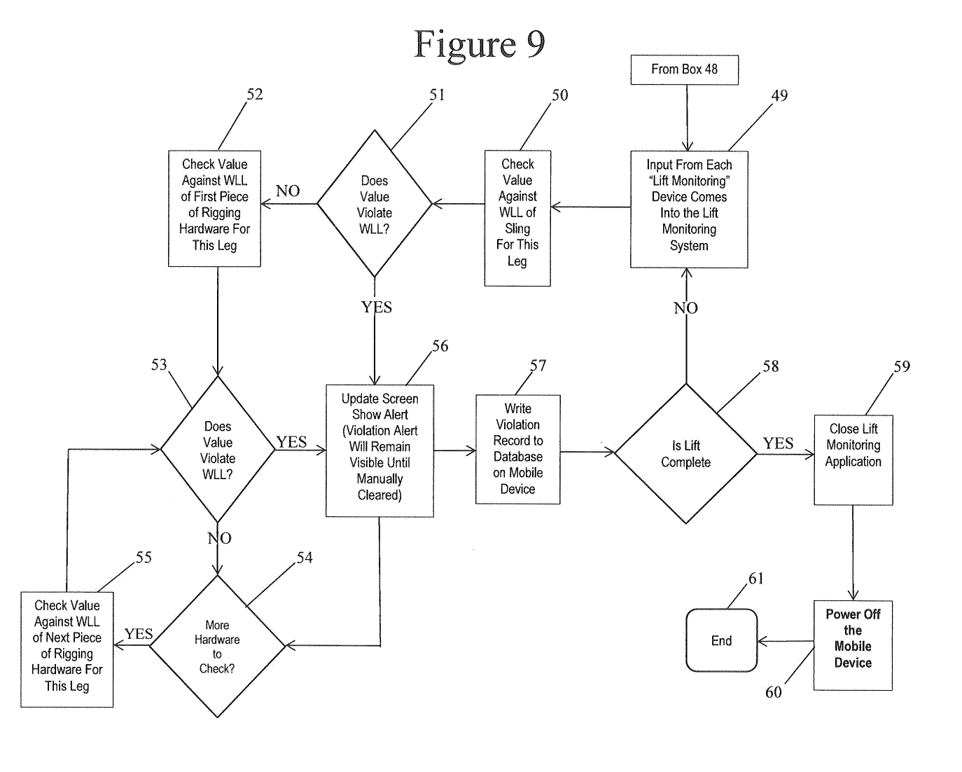

FIG. 9 is a sequential flow chart of the process flow during the lift operation.

Once the steps shown in FIG. 8 have been completed, the actual lift operation can start. As seen in Box 49, input from each of the lift monitoring devices is transmitted and is received by the mobile device. Once the load data comes into the system, the computer software program poses a series of questions and makes comparisons of that actual load data with what it is expecting to see.

As seen in Box 50, the incoming value (for “Leg 1”, for instance) will be checked against the appropriate sling capacity for that leg. If the tension is less than the sling's capacity, then, as seen in Box 52, check the same value (for “Leg 1”) against the first piece of equipment hardware in the list of hardware being used in that leg. If the tension is less than the current hardware piece capacity, as seen in Box 53, then it will be determined if there is more hardware to check as seen in Diamond 54. If there is no more hardware to check, just go to Diamond 58 and check to see if the lift is over.

If there is additional equipment to check, then, as seen in Box 55, similar to Step 52, check the same value (for “Leg 1”) against the next piece of hardware in the list of hardware being used in that leg.

As seen in Box 56, if the incoming load data or tension value is greater than the sling capacity or the capacity of any piece of hardware, an alert is generated and shown on the screen of the mobile receiving device. The equipment that triggered the event immediately gains the “overloaded” condition designation. Later receiving a tension value that is back under its capacity will not remove that condition.

As seen in Box 57, a time-stamped record of the overload gets written or delivered to a database on the mobile device and the lift continues. In addition, the mobile receiving device could transmit an alarm or alert to another computer or device. This information can be used in various ways. In the future, analytics could be run. For instance, if it is determined that a sling failure shows consistent patterns within the system, the user could be alerted that, based on this analysis, “Leg 3” might be suffering a sling or hardware failure.

If the lift operation is continuing, the user just feeds back into the loop. Otherwise, the user can close the application and power down the mobile receiving and transmitting device.

Once the lift has been completed, the monitoring software application is closed, as at Box 59. Thereafter, the mobile receiving device will be powered off, as shown at Box 60.

As can be seen by the foregoing, the present invention provides a system and method to design a load lift operation with a variety of lifting equipment, select all of the equipment appropriate to the lift operation, remotely monitor the equipment during the lift operation, send alerts of any overload conditions, and provide record keeping.

Whereas, the present invention has been described in relation to the drawings attached hereto, it should be understood that other and further modifications, apart from those shown or suggested herein, may be made within the spirit and scope of this invention.

What is claimed is:

1. A method of measurement, identification and analysis of material lifting products using remote monitoring, wherein the method comprises:
designing a lift plan for a load including selecting a plurality of legs;
connecting a required lift sensing and monitoring device for each of said plurality of legs;
assembling lifting equipment in accordance with said lift plan;
sensing a load from each of said lift sensing and monitoring devices during a lift operation;
transmitting load data from each of said lift sensing and monitoring devices during said lift operation to a mobile receiving device; and
generating an alert if any tension value from said load data is greater than capacity.

2. A method of measurement, identification and analysis of material lifting products as set forth in claim 1 wherein each said lift sensing and monitoring device includes a load cell or strain gauge and a wireless transmitter to transmit said load data.

3. A method of measurement, identification and analysis of material lifting products as set forth in claim 2 wherein said load cell or strain gauge is embedded in or connected to a hook.

4. A method of measurement, identification and analysis of material lifting products as set forth in claim 1 wherein said load cell or strain gauge is embedded in or connected to a hook.

5. A method of measurement, identification and analysis of material lifting products as set forth in claim 2 wherein said load cell or strain gauge is embedded in or connected to a shackle.

6. A method of measurement, identification and analysis of material lifting products wherein said load cell or strain gauge is embedded in a shackle.

7. A method of measurement, identification and analysis of material lifting products as set forth in claim 1 wherein said transmitted load data is wirelessly transmitted to a mobile receiving and transmitting device.

8. A method of measurement, identification and analysis of material lifting products as set forth in claim 1 wherein said mobile receiving and transmitting device includes a central processing unit, a database and a display.

9. A method of measurement, identification and analysis of material lifting products as set forth in claim 8 wherein said database includes lists of equipment and the attributes thereof.

10. A system of measurement, identification and analysis of material lifting products using remote monitoring, which system comprises:
an assembly of lifting equipment attached to a load, said equipment including a plurality of legs;
a lift sensing monitoring device connected to each of said plurality of legs;
load data transmitted from each said lift sensing and monitoring device;
a mobile receiving and transmitting device receiving said load data from each of said lift sensing and monitoring devices; and
an alarm generator in response to said load data.
